(19) United States
(12) Patent Application Publication
(10) Pub. No.: US 2025/0038333 A1
(43) Pub. Date: Jan. 30, 2025

(54) A PROTECTIVE CASING FOR A BATTERY PACK OF AN ELECTRIC VEHICLE

(71) Applicant: Oben Electric Vehicles Private Limited, Bangalore (IN)

(72) Inventors: Dinkar Agrawal, Bangalore (IN); Sagar Thakkar, Ahmedabad (IN); Shantanu Laxmikant Diwakar, Osmanabad (IN); Sagnik Deb, Hyderabad (IN)

(21) Appl. No.: 18/716,366

(22) PCT Filed: Feb. 15, 2023
(86) PCT No.: PCT/IB2023/051362

§ 371 Date: Jun. 4, 2024

(30) Foreign Application Priority Data
Apr. 4, 2022 (IN) 202241011796
Feb. 15, 2023 (WO) PCT/IB2023/051362

(51) Int. Cl. H01M 50/242; H01M 10/6551; H01M 50/227; H01M 50/249; H01M 50/256; H01M 50/278

(52) U.S. Cl. CPC H01M 50/242; H01M 10/6551; H01M 50/249; H01M 50/256; H01M 50/227; H01M 50/278; H01M 2220/20

(57) ABSTRACT

A protective casing for a battery pack of an electric vehicle is provided. The protective casing for a battery pack of an electric vehicle comprises a shock absorption casing, a top cover and a housing. The protective casing with ergonomic designs facilitates extra safety for the electric vehicle's battery pack. A plurality of protrusions on the outer surface of the shock absorption casing reduces the thickness of the shock absorption casing. The protective casing with shock absorption casing is configured to safeguard the housing and the battery pack by absorbing the shocks and vibration during battery swapping, rough usage of a battery, vehicle movement on uneven roads, and mechanical vibrations of the vehicle due to an electric motor in the electric vehicle.

### EARLIEST PRIORITY DATE

This Application claims priority from a Provisional patent application filed in India having patent application Ser. No. 20/224,1011796, filed on Mar. 4, 2022, and titled “BATTERY MODULE CASING WITH SHOCK ABSORPTION CAPABILITY” and also claims priority from a PCT patent application having Patent Application No. PCT/IB2023/051362, filed on Feb. 15, 2023, and titled “A PROTECTIVE CASING FOR A BATTERY PACK OF AN ELECTRIC VEHICLE”.

### FIELD OF INVENTION

Embodiments of the present disclosure relate to a protective casing for batteries, and more particularly to a protective casing for a battery pack of an electric vehicle.

### BACKGROUND

The battery pack is the most important component of an electric vehicle as the battery pack accommodates energy-storing battery cells. Electric vehicles use the energy stored in the battery cells of a battery pack to operate. Hence, it is vital to provide additional protection to the battery pack.

Conventionally, electric vehicles typically store battery packs within a deck surrounded by a frame of the electric vehicle. Electric vehicle frames protect the battery pack during vehicle operation and various events such as accidents, battery swapping, battery transportation, etc. In this case, the frame of the electric vehicle is damaged, which leads to damage to the battery pack, causing adverse effects. A damaged battery pack can eventually damage the internal battery cells, causing a fire and explosion.

In one conventional system, a battery module, which is resistant to shock and vibration with robustness is disclosed. This battery module comprises a vibration-shock absorbing part for absorbing vibrations and shocks in elastic contact with end faces of unit batteries, held in insertion-fitted in a battery retainer part of a battery retainer frame.

In another conventional system, a battery housing device having a plus terminal and a minus terminal, a plus pole spring is disclosed. The battery housing device is resistant to vibration and shock in order to prevent performance degradation of the battery.

U.S. Pat. No. 5,393,617A provides a bipolar electrochemical battery of stacked wafer cells, wherein the stack of cells is held in compression by means of a layer of sponge rubber between one or both of the metal foil contacts and the end plates, and respectively, of the outer housing. Alternatively, a spring or a gas-filled compressible pad is used instead of the sponge rubber. However, the inclusion of such an additional complaint part in the finished battery assembly is detrimental to the cost, volume, and weight of the resulting battery assembly.

U.S. Pat. No. 5,547,777A provides a fuel cell having uniform compressive stress distribution overactive area, which uses endplates, ties rods, and compliant pads. Although the mechanical approach for managing the forces on a cell stack is effective, however at the same time, this mechanical approach provides a heavy and bulky solution, which is not cost-effective for mass manufacturing.

Further, many electric vehicles use the battery swapping technique to recharge the battery pack before usage. The constant manual rough swapping of the battery pack also leads to damage to the battery pack. Damage to the surface of the battery pack ultimately affects the interior battery cells. The battery pack structural casing needs to be improved to minimize such mentioned damage effects.

Hence, there is a need for an improved protective casing for a battery pack of an electric vehicle, which is lightweight, cost-effective, and therefore addresses the aforementioned issues. Further, there is also a need for a protective casing with ergonomic designs that facilitates extra safety for the electric vehicle's battery pack.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present invention, a protective casing for a battery pack of an electric vehicle is provided. The protective casing for a battery pack of an electric vehicle comprises a housing, a top cover, and a shock absorption casing. The protective casing with ergonomic designs facilitates extra safety for the electric vehicle's battery pack.

The housing is configured to receive the battery pack of the electric vehicle and to protect the battery pack from external impacts. An outer surface of the housing is equipped with a plurality of fastener holes configured to fasten the protective casing to a chassis frame of the electric vehicle using fasteners. The material of the housing is selected from the group comprised of plastic, bioplastic, melamine, and bakelite.

The top cover disposed on the housing is configured to enclose the battery pack inside the housing. The top cover comprises a plurality of cable grommets and at least one carry handle. The plurality of cable grommets is configured to pass through a plurality of electric cables of the battery pack from the housing. The carry handle disposed on the top cover is configured to manoeuvre the protective casing during detrimental actions. The detrimental actions comprise, but not limited to, vehicle accidents, battery swapping, rough usage of a battery, vehicle movement on uneven roads, and mechanical vibrations of the vehicle due to an electric motor in the electric vehicle. The top cover is made of a material selected from the group comprised of plastic, bioplastic, melamine, and bakelite.

The shock absorption casing is disposed of around the housing. The shock absorption casing is configured to safeguard the housing and the battery pack by absorbing the shocks and vibration during detrimental actions. The shock absorption casing is affixed to the outer surface of the housing in a way that, shock absorption casing safeguards the edges of the housing and the surface of the housing expose to the ambient air to dissipate the heat from the battery pack.

The shock absorption casing is made of a material selected from the group comprised of damping materials including an ethylene propylene diene monomer (EPDM) rubber to safeguard the battery pack from external impacts, shocks, and vibration. Further, the shock absorption casing is equipped with a plurality of protrusions. The plurality of protrusions disposed on the outer surface of the shock absorption casing thereby reducing the thickness of the shock absorption casing. The plurality of protrusions is made of ethylene propylene diene monomer (EPDM) rubber and configured to provide cushioning to the protective casing.

The shock absorption casing is designed in a plurality of shapes configured to facilitate the effective dissipation of heat from the battery pack. The plurality of shapes comprises, but not limited to, an X-shaped structure, an H-shaped structure, and a V-shaped structure. The X-shaped structure connects the corners of the shock absorption casing and covers the surface of the housing. The H-shaped structure connects the edges of the shock absorption casing and covers the surface of the housing. The V-shaped structure connects one of the edges to the corners of the shock absorption casing and covers the surface of the housing.

To further clarify the advantages and features of the present invention, a more particular description of the invention will follow by reference to specific embodiments thereof, which are illustrated in the appended figures. It is to be appreciated that these figures depict only typical embodiments of the invention and are therefore not to be considered limiting in scope. The invention will be described and explained with additional specificity and detail with the appended figures.

### BRIEF DESCRIPTION OF THE DRAWINGS

The disclosure will be described and explained with additional specificity and detail with the accompanying figures in which:

FIG. 1 illustrates an exemplary isometric view of a protective casing for a battery pack of an electric vehicle, in accordance with an embodiment of the present invention;

FIG. 2 illustrates an exemplary front view of the protective casing for the battery pack of the electric vehicle, in accordance with an embodiment of the present disclosure;

FIG. 3 illustrates an exemplary perspective view of the protective casing for the battery pack of the electric vehicle, in accordance with an embodiment of the present disclosure;

FIG. 4 illustrates an exemplary side view of the protective casing for the battery pack of the electric vehicle, in accordance with an embodiment of the present disclosure;

FIG. 5 illustrates an exemplary rear view of the protective casing for the battery pack of the electric vehicle, in accordance with an embodiment of the present disclosure;

FIG. 6A illustrates an exemplary perspective view of an H-shaped shock absorption casing, in accordance with an embodiment of the present disclosure;

FIG. 6B illustrates an exemplary perspective view of an H-shaped structure having a plurality of protrusions of a shock absorption casing for the protective casing, in accordance with an embodiment of the present disclosure;

FIG. 7A illustrates an exemplary perspective view of an X-shaped shock absorption casing, in accordance with an embodiment of the present disclosure;

FIG. 7B illustrates an exemplary perspective view of an X-shaped shock absorption casing for the protective casing, in accordance with an embodiment of the present disclosure;

FIG. 8 illustrates an exemplary perspective view of a V-shaped structure of the shock absorption casing for the protective casing, in accordance with an embodiment of the present disclosure;

FIG. 9 illustrates an exemplary bottom perspective view of the protective casing for the battery pack of the electric vehicle mounted on a chassis frame, in accordance with an embodiment of the present disclosure;

FIG. 10 illustrates an exemplary side view of the protective casing for the battery pack of the electric vehicle mounted on the chassis frame, in accordance with an embodiment of the present disclosure;

FIG. 11 illustrates an exemplary detailed view of a carry handle of the protective casing, in accordance with an embodiment of the present disclosure;

FIG. 12 illustrates an exemplary top perspective view of the protective casing for the battery pack of the electric vehicle mounted on the chassis frame, in accordance with an embodiment of the present disclosure;

FIG. 13 illustrates an exemplary top view of the protective casing for the battery pack of the electric vehicle with the shock absorption casing, in accordance with an embodiment of the present disclosure; and

FIG. 14 illustrates an exemplary top-sectional view of the protective casing for the battery pack of the electric vehicle with the shock absorption casing, in accordance with an embodiment of the present disclosure.

Further, those skilled in the art will appreciate that elements in the figures are illustrated for simplicity and may not have necessarily been drawn to scale. Furthermore, in terms of the method steps, chemical compounds, equipments and parameters used herein may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE PRESENT INVENTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more components, compounds, and ingredients preceded by “comprises . . . a” does not, without more constraints, preclude the existence of other components or compounds or ingredients or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present invention relate to a protective casing for a battery pack of an electric vehicle with shock absorption capabilities.

As used herein the term “casing” refers to a cover or a guard that protects or encloses something fully or partially based on the design.

As used herein the term “electric vehicle” refers to a vehicle that can be powered by an electric motor that draws electricity from a battery pack and is capable of being charged from an external source. Herein one embodiment, the electric vehicle includes two-wheeler vehicles comprises, but not limited to, an electric motorcycle, an electric scooter, an electric bicycle, a three-wheeler vehicle comprise, but limited to, auto-rickshaws, tuk-tuks, trishaws, autos, rickshaws, autoricks, bajajs, ricks, tricycles, mototaxis and baby taxis, a four-wheeler or a multi-wheeler vehicles includes, but not limited to, a car, jeep, a truck, a bus, and thereof.

As used herein the term “ethylene propylene diene monomer (EPDM)” refers to a type of synthetic rubber commonly used to absorb external impacts or shocks effectively.

As used herein the term “fastener holes” refer to a through hole having threading to receive the fastener to join or affix two or more objects together.

As used herein the term “fastener” refers to a hardware device that mechanically joins or affixes two or more objects together. In general, fasteners are used to create non-permanent joints; that is, joints that can be removed or dismantled without damaging the joining components.

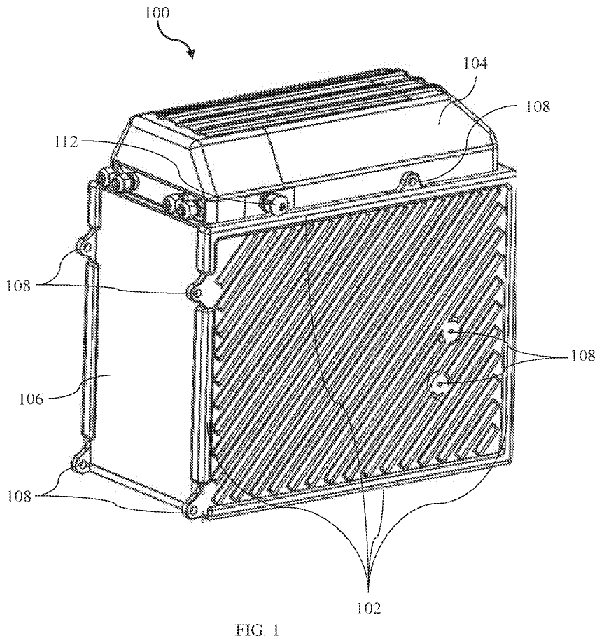

FIG. 1 refers to an exemplary isometric view of a protective casing 100 for a battery pack of an electric vehicle. According to an exemplary embodiment of the invention, the protective casing 100 for a battery pack of an electric vehicle comprises a housing 106, a top cover 104, and a shock absorption casing 102. The protective casing with ergonomic designs facilitates extra safety for the electric vehicle's battery pack. Electric vehicles operate with an electric energy source, which is generated and provided in real-time by electrical energy cells of the battery pack enclosed in the protective casing 100. In such an embodiment, the protective casing 100 is mechanically coupled to a chassis frame.

The housing 106 is a robust unit in the shape of the battery pack. The shape of the housing 106 may be altered based on the size and shape of the battery pack. The housing 106 is configured to receive the battery pack of the electric vehicle and to protect the battery pack from external impacts. Herein one embodiment, the housing 106 is in the shape of, but not limited to, rectangular with one side opening to receive the battery pack inside it. An outer surface of the housing 106 is equipped with a plurality of fastener holes 108.

Herein another embodiment, some of the fastener holes 108 are protruded out from the housing 106 and some of the fastener holes 108 positioned on the outer surface of the housing 106. The fastener holes 108 are configured to enables the housing 106 to fasten with the chassis frame of the electric vehicle using fasteners. In an embodiment herein, the material of the housing 106 is selected from the group comprises, but not limited to, a plastic, a bioplastic, a melamine, and a bakelite and thereof.

The top cover 104 disposed on the housing 106 is configured to enclose the battery pack inside the housing 106. The top cover 104 is optionally removable for battery pack replacement or any other battery service functions. The top cover 104 is made of a material selected from the group comprises, but not limited to, a plastic, a bioplastic, a melamine, and a bakelite. Herein one embodiment, the top cover 104 affixed to the housing 106 by using a plurality of screws 112.

The shock absorption casing 102 is disposed of around the housing 106. Herein one embodiment, the shock absorption casing 102 includes a plurality of straps combined to form a structure to protect the edges of the housing 106. The shock absorption casing 102 is configured to safeguard the housing 106 and the battery pack by absorbing the shocks and vibration during detrimental actions. The plurality of straps of the shock absorption casing 102 is affixed to the outer surface of the housing in a way that, the plurality of straps of the shock absorption casing safeguards the edges of the housing 106. Whereas the surface 204 of the housing 106 expose to the ambient air to dissipate the heat from the battery pack.

The shock absorption casing 102 is made of a material selected from the group that comprises, but not limited to, damping materials including an ethylene propylene diene monomer (EPDM) rubber to safeguard the battery pack from external impacts, shocks, and vibration. Further, the shock absorption casing 102 is equipped with a plurality of protrusions. The plurality of protrusions disposed on the outer surface of the shock absorption casing 102 thereby reducing the thickness of the shock absorption casing 102. The plurality of protrusions is made of, but not limited to, a ethylene propylene diene monomer (EPDM) rubber and configured to provide cushioning to the protective casing 100.

The shock absorption casing 102 is designed in a plurality of shapes configured to facilitate the effective dissipation of heat from the battery pack and to safeguard the battery pack from external shocks. The plurality of shapes comprises, but not limited to, an X-shaped structure, an H-shaped structure, and a V-shaped structure. The X-shaped structure having a plurality of straps connects the corners of the shock absorption casing 102 and partially covers the surface 202 of the housing 106. The H-shaped structure having a plurality of straps connects the edges of the shock absorption casing 102 and partially covers the surface 202 of the housing 106. The V-shaped structure having a plurality of straps connects one of the edges to the opposite corners of the shock absorption casing 102 and partially covers the surface 202 of the housing 106.

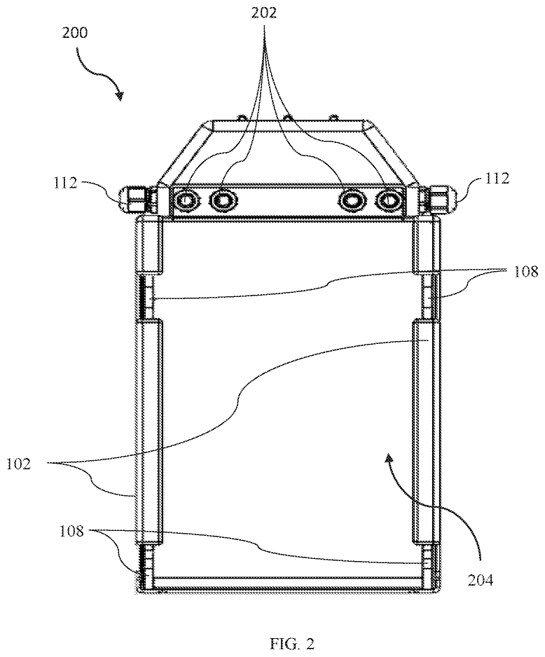

FIG. 2 refers to an exemplary front view 200 of the protective casing 100 for the battery pack of the electric vehicle, in accordance with an embodiment of the present disclosure.

According to another exemplary embodiment of the invention, the top cover 104 disposed on the housing 106 is configured to enclose the battery pack inside the housing 106. The top cover 106 comprises a plurality of cable grommets 202. The plurality of cable grommets 202 is configured to allow a plurality of electric cables of the battery pack to pass through from the housing 106. The housing 106 is protected by the shock absorption casing 102, whereas the shock absorption casing 102 is designed to have plurality of cut to accommodate the fastener holes 108. Herein one embodiment, the shock absorption casing 102 configured to protect the edges of the housing 106 and the surface 204 of the housing 106 is exposed to the ambient air.

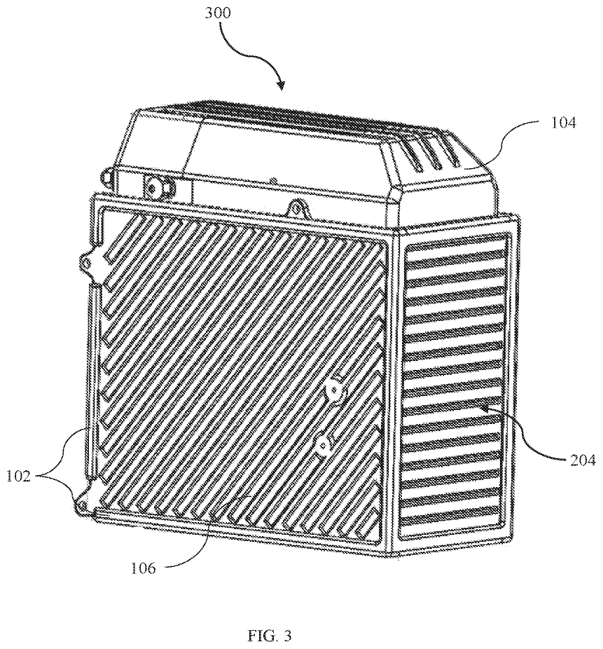

FIG. 3 illustrates an exemplary perspective view 300 of the protective casing 100 for the battery pack of the electric vehicle, in accordance with an embodiment of the present disclosure.

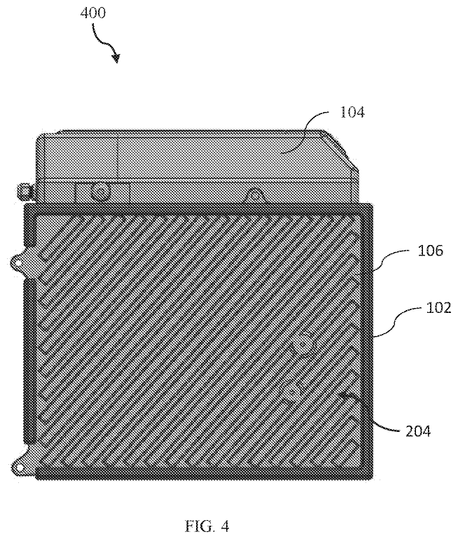

FIG. 4 illustrates an exemplary side view 400 of the protective casing 100 for the battery pack of the electric vehicle, in accordance with an embodiment of the present disclosure.

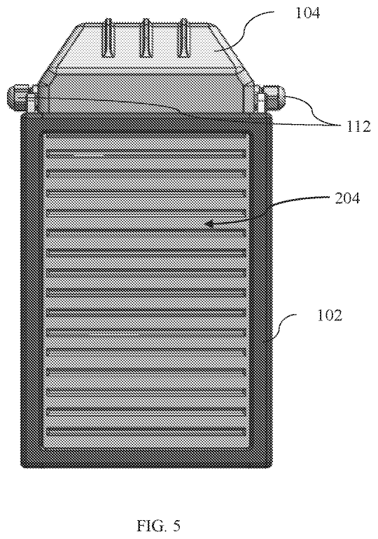

FIG. 5 illustrates an exemplary rear view 500 of the protective casing 100 for the battery pack of the electric vehicle, in accordance with an embodiment of the present disclosure.

In another exemplary embodiment herein, the shock absorption casing 102 is mounted on the housing 106 by stretching the plurality of straps around the edges of the housing 106. The shock absorption casing 102 is elastic in nature and has viscous properties such as high inherent damping, deflection capacity, and energy storage. The thickness of the plurality of straps of the shock absorption casing 102 is configured to vary based on the weight of the protective casing 100. The shock absorption casing 102 is configured to be adjusted as per length, height, and breadth of the housing 106. In an embodiment herein, the surface 202 of the housing 106 is configured with a plurality of patterns to make the housing robust and make the housing 106 aesthetic.

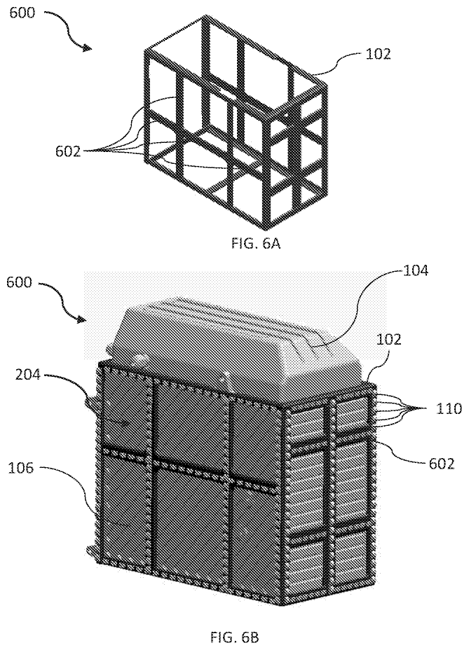

FIG. 6A illustrates an exemplary perspective view of an H-shaped structure 600 of the shock absorption casing, in accordance with an embodiment of the present disclosure.

FIG. 6B illustrates an exemplary perspective view of an H-shaped structure 600 having a plurality of protrusions 110 of a shock absorption casing for the protective casing 100, in accordance with an embodiment of the present disclosure.

According to another embodiment of the invention, the protective casing 100 for a battery pack of an electric vehicle having shock absorption casing 102. Herein one embodiment, the design of the shock absorption casing 102 is in H-shaped structure 600. The H-shaped structure 600 of the shock absorption casing 102 is formed by using a plurality of straps 602. The plurality of straps 602 is configured to connect the edges of the shock absorption casing 102 in such a way that the surface 204 of the housing 106 is partially covered by the plurality of straps 602.

Herein one embodiment, the shock absorption casing 102 is equipped with a plurality of protrusions 110. The plurality of protrusions 110 disposed on the outer surface of the shock absorption casing 102 thereby reducing the thickness of the shock absorption casing 102. The plurality of protrusions is made of, but not limited to, a ethylene propylene diene monomer (EPDM) rubber and configured to provide cushioning to the protective casing 100. The thickness of the shock absorption casing 102 is at least 1 millimeter (mm) less than dimensions of length, breadth, and height of the housing 106. The shock absorption casing 102 are enabled to stretch and fit over the housing 106. For instance, when the housing 106 has a casing size of 100×200×300 mm, then size of the shock absorption casing 102 is at least 99×199×299 mm for the ease of grip and fits over the housing 106.

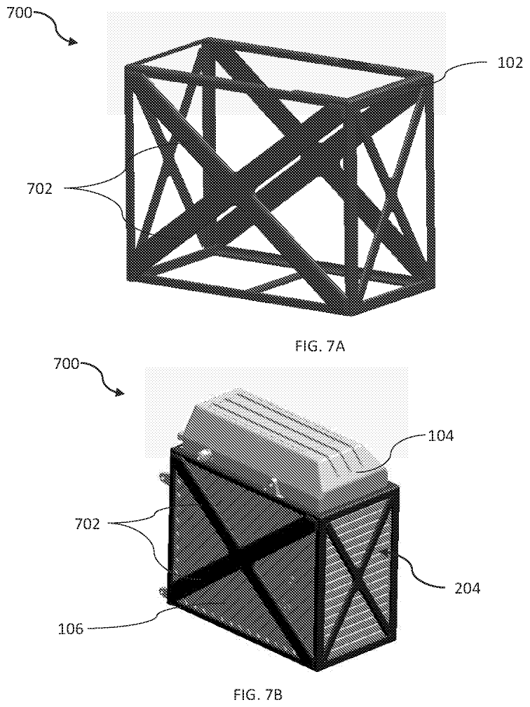

FIG. 7A illustrates an exemplary perspective view of an X-shaped structure 700 of the shock absorption casing, in accordance with an embodiment of the present disclosure.

FIG. 7B illustrates an exemplary perspective view of an X-shaped structure 700 of the shock absorption casing for the protective casing, in accordance with an embodiment of the present disclosure.

According to another embodiment of the invention, the protective casing 100 for a battery pack of an electric vehicle having shock absorption casing 102. Herein one embodiment, the design of the shock absorption casing 102 is in the X-shaped structure 700. The X-shaped structure 700 of the shock absorption casing 102 is formed by using a plurality of straps 702. The plurality of straps 602 is configured to connect the corners of the shock absorption casing 102 in such a way that the surface 204 of the housing 106 is partially covered by the plurality of straps 702.

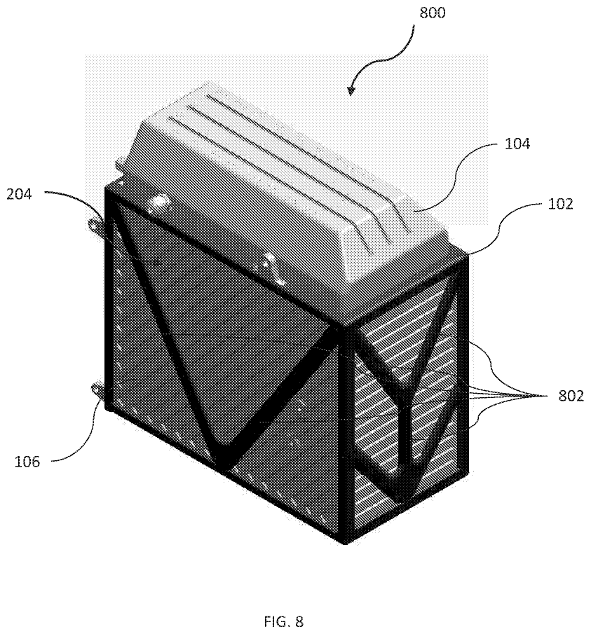

FIG. 8 illustrates an exemplary perspective view of a V-shaped structure 800 of the shock absorption casing for the protective casing, in accordance with an embodiment of the present disclosure.

According to another embodiment of the invention, the protective casing 100 for a battery pack of an electric vehicle has shock absorption casing 102. Herein one embodiment, the design of the shock absorption casing 102 is in the V-shaped structure 800. The V-shaped structure 800 of the shock absorption casing 102 is formed by using a plurality of straps 802. The plurality of straps 802 is configured to connect one of the shock absorption casing 102 edge to the corners of the shock absorption casing 102. The plurality of straps 802 is connected in a way that the surface 202 of the housing 106 is partially covered by the plurality of straps 802.

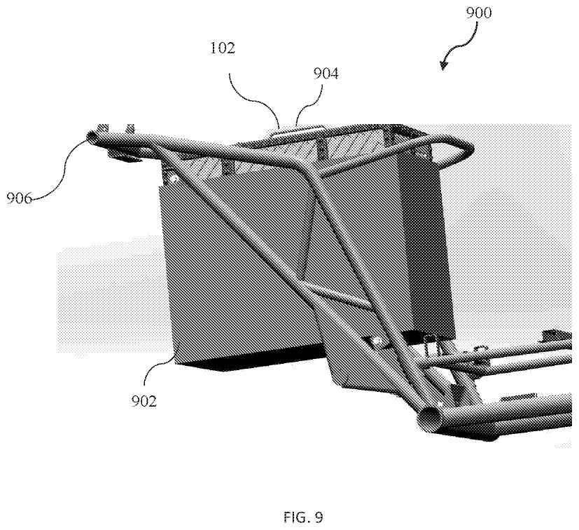

FIG. 9 illustrates an exemplary bottom perspective view 900 of the protective casing 100 for the battery pack of the electric vehicle mounted on a chassis frame 906, in accordance with an embodiment of the present disclosure.

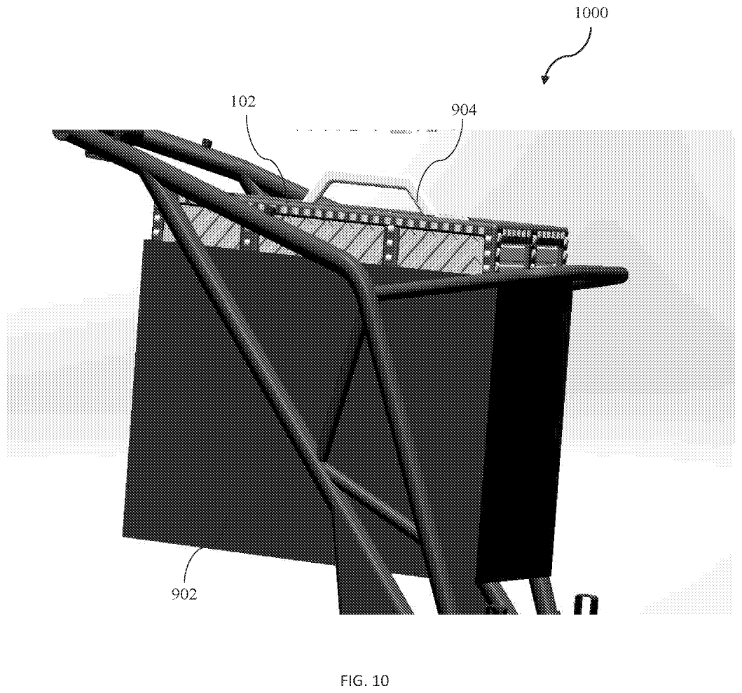

FIG. 10 illustrates an exemplary side view 1000 of the protective casing 100 for the battery pack of the electric vehicle mounted on the chassis frame 906, in accordance with an embodiment of the present disclosure.

According to another embodiment of the invention, the protective casing 100 is mounted on the chassis frame 906 by using a subframe 902. The shape of the subframe 902 is almost similar to the housing of the battery pack that is arranged beneath a seat of the electric vehicle. The subframe 902 is fasten with the chassis frame 906. The subframe 902 is configured to receive the protective casing 100. The subframe 902 is having tolerance of at least 1 millimeter for easy insertion of protective casing 100. The top cover 104 of the protective casing 100 is equipped with at least one carry handle 904. The at least one carry handle 904 is configured to manoeuvre the protective casing 100 from the subframe 902 during the detrimental actions. The detrimental actions comprises, but not limited to, vehicle accidents, battery swapping, rough usage of a battery, vehicle movement on uneven roads, and mechanical vibrations of the vehicle due to an electric motor in the electric vehicle.

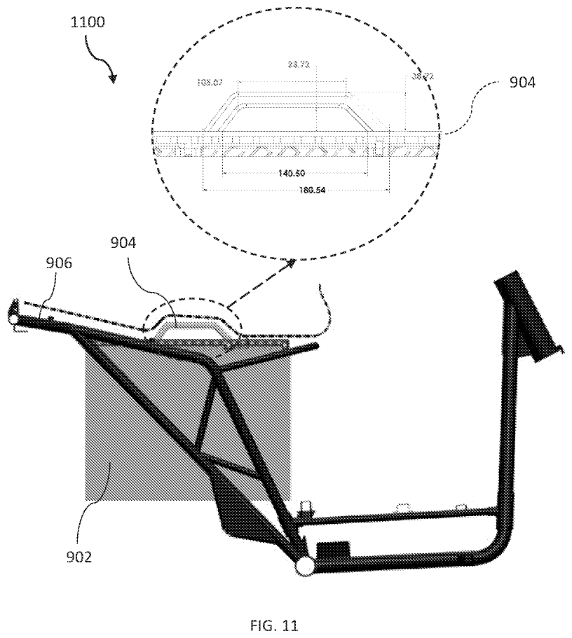

FIG. 11 illustrates an exemplary detailed view 1100 of a carry handle 904 of the protective casing 100, in accordance with an embodiment of the present disclosure.

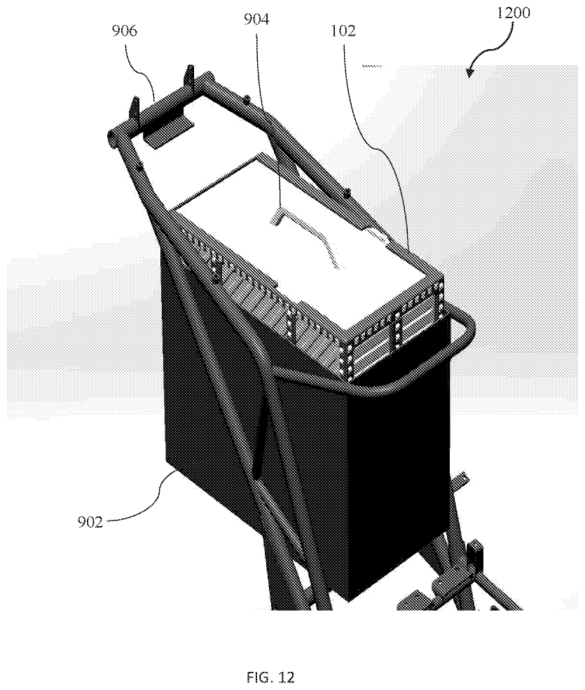

FIG. 12 illustrates an exemplary top perspective view 1200 of the protective casing 100 for the battery pack of the electric vehicle mounted on the chassis frame 906, in accordance with an embodiment of the present disclosure.

According to another embodiment of the invention, the protective casing 100 is installed on the chassis frame 906 by using the subframe 902. The top cover 104 of the protective casing 100 is equipped with at least one carry handle 904. The at least one carry handle 904 is configured to manoeuvre the protective casing 100 from the subframe 902 during the detrimental actions. Herein one embodiment, the dimensions of the carry handle 904 is shown in the FIG. 11. The carry handle 904 may be pivoted to the top surface of the top cover 104 by a fastening means. Herein one embodiment, the top cover 104 may comprises recess for resting the carry handle 904 in a stowed position. In another embodiment herein, the seat of the electric vehicle also having a recess for the carry handle 904.

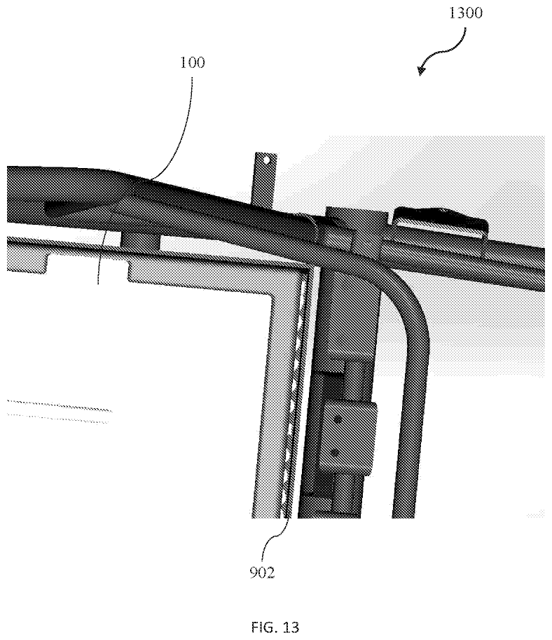

FIG. 13 illustrates an exemplary top view 1300 of the protective casing 100 for the battery pack of the electric vehicle with the shock absorption casing 102, in accordance with an embodiment of the present disclosure; and

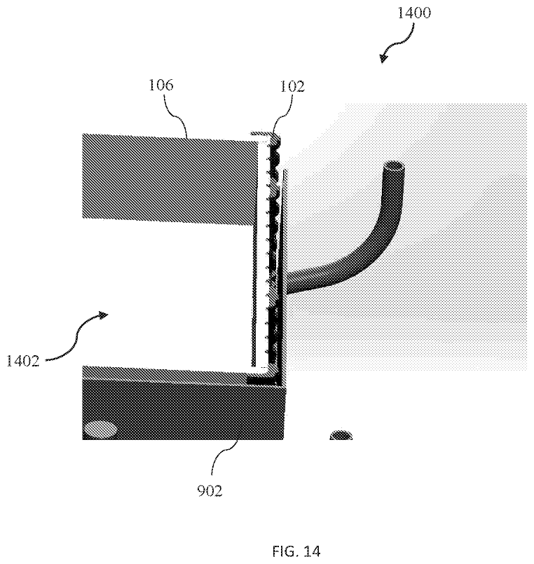

FIG. 14 illustrates an exemplary top-sectional view 1400 of the protective casing 100 for the battery pack of the electric vehicle with the shock absorption casing 102, in accordance with an embodiment of the present disclosure.

According to another embodiment of the invention, the protective casing 100 is installed on the chassis frame 906 by using the subframe 902. The subframe 902 is having tolerance of at least 1 millimeter for easy insertion of protective casing 100. The subframe 902 is configured to receive the protective casing 100. The housing 106 having internal surface 1402 configured to receive the battery pack of the electric vehicle. The protective casing 100 with ergonomic designs facilitates extra safety for the electric vehicle's battery pack.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I/we claim:

1. A protective casing for a battery pack of an electric vehicle, comprising:
a housing configured to receive the battery pack of the electric vehicle and to protect the battery pack from external impacts;
a top cover disposed on the housing configured to enclose the battery pack inside the housing, wherein the top cover comprises:
a plurality of cable grommets configured to pass through a plurality of electric cables of the battery pack from the housing;
at least one carry handle disposed on the top cover configured to maneuver the protective casing during detrimental actions; and
a shock absorption casing disposed around the housing configured to safeguard the housing and the battery pack by absorbing the shocks and vibration during the detrimental actions,
whereby the protective casing with ergonomic design facilitates extra safety to the electric vehicle's battery pack.

2. The protective casing for a battery pack of an electric vehicle as claimed in claim 1, wherein an outer surface of the housing is equipped with a plurality of fastener holes configured to fasten the protective casing to a chassis frame of the electric vehicle using fasteners.

3. The protective casing for a battery pack of an electric vehicle as claimed in claim 1, wherein the material of the housing and the top cover is selected from the group comprises of a plastic, a bioplastic, a melamine, and a bakelite.

4. The protective casing for a battery pack of an electric vehicle as claimed in claim 1, wherein the detrimental actions comprise vehicle accidents, battery swapping, rough usage of a battery, vehicle movement on uneven roads, and mechanical vibrations of the vehicle due to an electric motor in the electric vehicle.

5. The protective casing for a battery pack of an electric vehicle as claimed in claim 1, wherein the shock absorption casing is affixed to the outer surface of the housing in a way that, the shock absorption casing safeguard the edges of the housing and the surface of the housing expose to the ambient air to dissipate the heat from the battery pack.

6. The protective casing for a battery pack of an electric vehicle as claimed in claim 1, wherein materials of the shock absorption casing are selected from the group comprised of damping materials including an ethylene propylene diene monomer (EPDM) rubber to safeguard the battery pack from the external impacts, shocks, and vibration.

7. The protective casing for a battery pack of an electric vehicle as claimed in claim 1, wherein
a plurality of protrusions disposed on the outer surface of the shock absorption casing thereby reducing the thickness of the shock absorption casing; and
the plurality of protrusions is made of ethylene propylene diene monomer (EPDM) rubber and configured to provide cushioning to the protective casing.

8. The protective casing for a battery pack of an electric vehicle as claimed in claim 1, wherein the shock absorption casing is designed in a plurality of shapes configured to facilitate effective dissipation of heat from the battery pack,
the plurality of shapes comprises:
an X-shaped structure having a plurality of straps connects the corners of the shock absorption casing to partially covers the surface of the housing;
an H-shaped structure having a plurality of straps connects the edges of the shock absorption casing to partially covers the surface of the housing; and
a V-shaped structure having a plurality of straps connects one of the edges to the corners of the shock absorption casing to partially covers the surface of the housing.
